(19) United States
(12) Patent Application Publication
(10) Pub. No.: US 2010/0163429 A1
(43) Pub. Date: Jul. 1, 2010

(54) GAS SENSING MATERIAL AND GAS SENSOR EMPLOYING THE SAME

(75) Inventors: Kuo-Chuang Chiu, Hsinchu City (TW); Ren-Der Jean, Hsinchu City (TW); Jinn-Shing King, Hsinchu (TW); Ming-Tsung Hong, Sanchong City (TW); Shur-Fen Liu, Baoshan Township (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/477,876

(22) Filed: Jun. 3, 2009

(30) Foreign Application Priority Data
Dec. 31, 2008 (TW) 097151785

(51) Int. Cl. G01N 27/26

(52) U.S. Cl. 205/775; 204/400

(57) ABSTRACT

Gas sensing material and gas sensor employing the same are provided. The gas sensing material includes an inorganic metal oxide and an organic polymer, wherein the organic polymer includes a repeat unit having the structure of

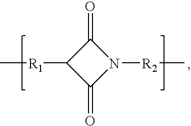

wherein R₁ and R₂ are an independent alkyl group, alkoxy group, alkoxycarbonyl group, aryl group, heteroaryl group, or aliphatic group.

### CROSS REFERENCE TO RELATED APPLICATIONS

This application is based upon and claims the benefit of priority from the prior Taiwan Patent Application No. 97151785, filed on Dec. 31, 2008, the entire contents of which are incorporated herein by reference.

### BACKGROUND OF THE INVENTION

1. Field of the Invention

The invention relates to a gas sensor, and more particularly to a gas sensor sufficiently operating at low temperatures.

2. Description of the Related Art

The quantitative and qualitative analysis of gases and their mixtures are applied in the fields of global environmental monitoring, household safety, greenhouse environmental control, chemical concentration control, and certain applications relating to the aerospace industry, etc. Many toxic gases (e.g. CO, NOx, H₂S, and CH₄, etc.) are harmful to the human health. The toxic gases are colorless and odorless such that they cannot be detected by the human senses of vision and smell. Thus, when toxic gas concentrations exceeds a certain level, symptoms such as headaches, dizziness, vomiting, or shock and death may occur to humans breathing the toxic gas. As such, gas analysis instruments or devices have been disclosed to monitor gas compositions in an enclosed space or an environment with poor ventilation in real time, thereby, providing an early warning system and preventing toxic gas poisoning.

An atomic/molecular absorption spectrometry, atomic/molecular fluorescence spectrometry, and gas chromatography instrument are commonly used for gas analysis in labs and for quality control of gases. The gas analysis instruments have the advantages of high accuracy, high sensitivity, and low detection limits. However, application is limited due to large sizes with low portability, high power consumption, structural complexity, and high costs.

A gas sensor is a device for converting detected gas concentrations into an electric signal, and is less cumbersome and costly than the gas analysis instruments described previously. Nowadays, it is common to use gas sensors for quantitative and qualitative analysis of gases and their mixtures, for real time monitoring and decreasing manual labor costs.

Conventional gas sensors include: solid electrolysis gas sensor, electrochemical gas sensor, and semiconductor absorbing gas sensor, etc.

U.S. Pat. No. 4,908,118, U.S. Pat. No. 4,976,991, and U.S. Pat. No. 5,453,172 disclose solid electrolysis gas sensors including a solid ionic conductor serving as electrolytes and at least two electrocatalytic electrodes. Solid electrolysis gas sensors measure gas concentrations for a desired gas by determining the potential difference between the two electrocatalytic electrodes.

Although an electrochemical gas sensor can detect gas concentrations at room temperature, the reference electrode thereof is liable to chemical buildup which causes drifting of the gas detection baseline. Thus, recalibration is required which is inconvenient for users. Additionally, a strong corrosive acid or base is required for the major part of the electrolyte of electrochemical gas sensor, thereby limiting operating lifespan of the sensor to 1-2 years.

A semiconductor absorbing gas sensor uses resistance variations caused by the amount of gas adsorbed on the surface of a metal compound to monitor gas concentration variations in the surrounding environment of the sensor. Such a gas sensor has the following advantages: good heat resistance and corrosion resistance, simple fabrication processes, easy implementation with microelectromechanical techniques, low power consumption, and commercial applicability, etc.

Referring to FIG. 1, a conventional semiconductor absorbing gas sensor 10 includes a thermal resistant substrate 12 (such as ceramic substrate), a sensing material layer 14, an electric resistance heater 16 (such as RuO₂), a first electrode 18 and a second electrode 20, wherein the sensing material layer 14 mainly consists of a polycrystalline and porous film of a metal oxide. For example, SnO₂, ZnO (disclosed in U.S. Pat. No. 4,358,951), F₂O₃, In₂O₃, and WO₃, are all suitable sensing materials for a sensing material layer of a conventional semiconductor absorbing gas sensor.

Major deficiencies of the conventional semiconductor absorbing gas sensor, however, include poor gas sensitivity, gas selectivity, and stability. Thus, conventionally, in order to accelerate the desorption rate of a gas chemically adsorbed on the surface of a conventional sensing material of the conventional semiconductor absorbing gas sensor, thus enhancing response time of the sensor, a heater is required and sufficient operating temperatures thereof must be above 300° C. However, with heating, size of the sensor is increased and power consumption is increased, thus increasing costs. In addition, costs are also increased due to the requirement for maintaining a high constant temperature.

U.S. Pat. No. 5,273,779 discloses the addition of noble metals to the SnO2 substrate, to enhance the sensitivity of the sensor via catalyst effect. However, the fabrication process is complicated and costly due to the noble metals required and multiple heat treatments. In addition, the gas sensor cannot sufficiently operate at low temperatures.

U.S. Pat. No. 6,134,946 discloses a SnO₂ gas sensor for the detection of carbon monoxide, hydrocarbons, and organic vapors. The preparation includes depositing tin oxide sol on Pt electrodes of a sensor. The thin film of tin oxide has a nano-crystalline structure with good stability. However, the operating temperature of the thermal treatment of the sensing material layer is about 700° C., and the gas sensor cannot sufficiently operate at low temperatures.

Thus, the aforementioned sensors only sufficiently operate at temperatures above 300° C. There is, therefore, still a need for a highly stable and sensitive gas sensor that sufficiently operates at low temperatures.

### BRIEF SUMMARY OF THE INVENTION

An exemplary embodiment of a gas sensing material includes an inorganic metal oxide and an organic polymer, wherein the organic polymer includes a repeat unit having the structure of

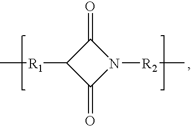

wherein R₁ and R₂ are an independent alkyl group, alkoxy group, alkoxycarbonyl group, aryl group, heteroaryl group, or aliphatic group.

An exemplary embodiment of a gas sensor includes a substrate, two separated electrodes disposed on the substrate, and a gas sensing film disposed on the substrate and contacting the two separated electrodes simultaneously, wherein the gas sensing film includes the gas sensing material of the invention.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a cross-section view of a conventional semiconductor absorbing gas sensor.

FIG. 2 shows a cross-section view of a gas sensor according to an embodiment of the invention.

FIG. 3 shows a schematic diagram illustrating the inner structure of the gas sensing film of a gas sensor according to an embodiment of the invention.

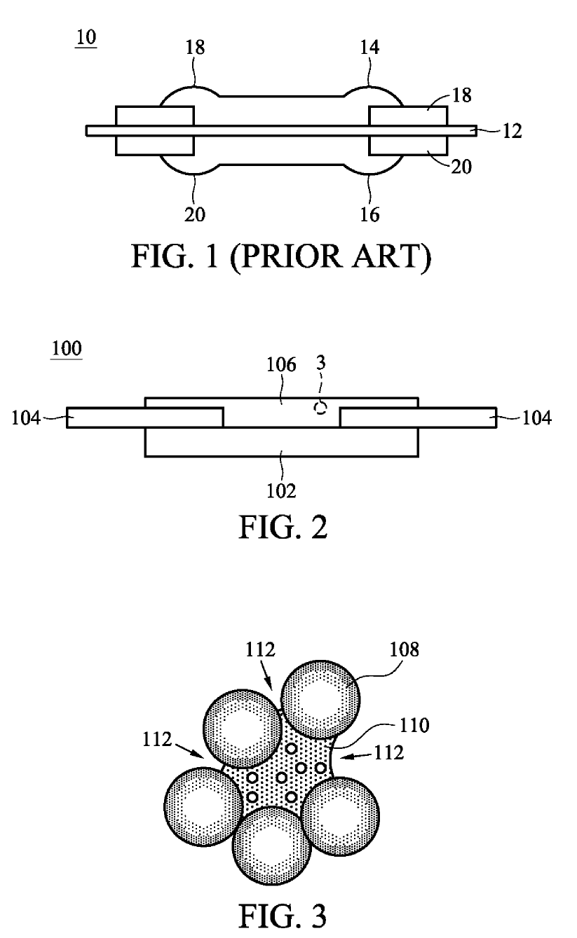

### DETAILED DESCRIPTION OF THE INVENTION

According to an embodiment of the invention, the gas sensing material of the invention includes an inorganic metal oxide, and an organic polymer. The inorganic metal oxide is present in an amount of 20-60 parts by weight, preferably 33˜50 parts by weight. The organic polymer is present in an amount of 40-80 parts by weight, preferably 50-67 parts by weight. The gas sensing material can further include a polymer dispersant with 1-30 parts by weight, based on the 100 parts by weight of the inorganic metal oxide and the organic polymer.

The inorganic metal oxide includes SnO₂, ZnO, LaFeO₃, IN₂O₃, WO₃, Ag₂O, or combinations thereof. The organic polymer can include a repeat unit having the structure of

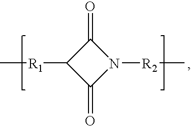

wherein R₁ and R₂ are an independent alkyl group, alkoxy group, alkoxycarbonyl group, aryl group, heteroaryl group, or aliphatic group.

For conventional semiconductor absorbing gas sensors, an additional heating source is provided to heat the inorganic metal oxide to enhance the carrier mobility thereof. Thus, operating temperature greater than 300° C. is required.

In order to reduce the operating temperature of the gas sensor, the gas sensing materials of the invention include organic polymers with a specific structure. The interaction between the organic polymers and a desired gas includes simple adsorption and coordination. In addition, the ability of the organic polymers to absorb a desired gas can be enhanced via dipole-dipole force, dipole-induce dipole force, London dispersion force, or hydrogen bonding force therebetween.

Therefore, the gas sensor of the invention has stable sensing ability and high gas sensitivity and gas selectivity. Further, the gas sensor of the invention achieves the requirement of low-temperature (or room-temperature) sensing.

According to another embodiment of the invention, the gas sensing material further includes: a polymer dispersant, wherein the polymer dispersant is present in an amount of 10-30 parts by weight, based on the 100 parts by weight of the inorganic metal oxide and the organic polymer. The polymer dispersant can include polyester, polyimide, or copolymer thereof.

The process for preparing the gas sensing material includes providing an inorganic metal oxide to mix with an organic polymer, then optionally adding a polymer dispersant or a solvent into the mixture. Thereafter, the mixture is distributed by a high-speed mixer or a ball mill for preparing an inorganic/organic composition. Next, the inorganic/organic composition is coated on a substrate and baked by an oven, thus obtaining the gas sensing material. Particularly, the method for coating the inorganic/organic composition includes a spin coating, a dip coating, a roll coating, or a blade coating method. The temperature for baking the gas sensing material is not more than 400° C.

According to some embodiments of the invention, referring to FIG. 2, the gas sensor 100 can include a substrate 102, two separated electrodes 104 disposed on the substrate 102, and a gas sensing film 106 disposed on the substrate 102 and contacting the two separated electrodes 104 simultaneously. FIG. 3 is a schematic diagram illustrating the inner structure 3 of the gas sensing film 106. The gas sensing film 106 includes an inorganic metal oxide powder 108 and an organic polymer 110. The organic polymer 110 adsorbs carbon monoxide 112 via pores of the gas sensing film 106 and generates a variance, and then the inorganic metal oxide 108 amplifies the measured variance (such as electrical resistance), thereby providing a way to analyze the concentration of carbon monoxide 112. The substrate can be nonconductive or insulated material, such as glass, ceramics, or quartz. It should be noted that since the gas sensor of the invention is suitable for sensing a desired gas at a low temperature, the substrate can be a plastic substrate for reducing cost. The materials of the two separated electrodes can be independent made of Pt, Au, Ag, or alloys thereof. The shape of the electrodes is not limited and includes comb-shaped, or strip-shaped electrodes. The gas sensing film 106 includes the gas sensing material of the invention, and the electric resistance, electric capacity, or inductance of the gas sensing film varies after adsorption of a desired gas. The method for forming the gas sensing film includes a spin coating, a dip coating, a roll coating, or a blade coating method. The gas sensing film of the invention can be formed at a temperature of not more than 400° C., thus, additionally costs due to the higher required temperature of conventional methods are saved. The gas sensing film of the invention is able to sense a desired gas at a temperature of not more than 250° C. and also perform gas desorption at a temperature of not more than 250° C.

The following examples are intended to illustrate the invention more fully without limiting the scope of the invention, since numerous modifications and variations will be apparent to those skilled in this art.

Preparation of Gas Sensing Material Composition

### Example 1

A polyimide precursor (with a solid content of 16%), tin dioxide powders, and a polymer dispersant were added into N-methyl-2-pyrrolidone, wherein the polymer dispersant was present in an amount of 10 parts by weight, based on the 100 parts by weight of the tin dioxide powders and the polyimide precursor. The mixture was stirred by a high-speed mixer and distributed by a ball mill for 12-36 hrs, thus obtaining gas sensing material compositions (A)-(D). The gas sensing material compositions (A)-(D) were prepared with various composition ratios shown in Table 1.

TABLE 1

| | polyimide | tin dioxide |
|---|---|---|
| | precursor (wt %) | powder (wt %) |
| gas sensing material composition (A) | 80 | 20 |
| gas sensing material composition (B) | 70 | 30 |
| gas sensing material composition (C) | 60 | 40 |
| gas sensing material composition (D) | 50 | 50 |

Preparation of Gas Sensors

### Example 2

A pair of Ag electrodes was formed on a plastic substrate (made of PMMA with a size of 10×5 mm) by screen printing, wherein the two Ag electrodes were separated. Next, the gas sensing material composition (A) was coated on the plastic substrate by a blade coating process to form a coating. Next, after baking at 120° C. for 20 minutes, the coating was baked in an oven at 350° C. for 1 hr for polymerizing the polyimide precursor to form a gas sensing film (with a thickness of 0.01 mm) on the substrate, thus obtaining a gas sensor (A).

The preparation of the gas sensors (B)-(D) were performed as the aforementioned process described except for respective substitution of the gas sensing film thicknesses of 0.05 mm, 0.1 mm, and 0.14 mm with 0.01 mm for gas sensor (A).

### Example 3

A pair of Ag electrodes was formed on a plastic substrate (made of PMMA with a size of 10×5 mm) by screen printing, wherein the two Ag electrodes were separated. Next, the gas sensing material compositions (A)-(D) were coated respectively on each plastic substrates by a blade coating process to form coatings. Next, after baking at 120° C. for 20 minutes, the coatings were baked in an oven at 350° C. for 1 hr for polymerizing the polyimide precursor to form gas sensing films (with the same thickness) on each substrates, thus obtaining a gas sensors (E)-(H).

Measurement of Gas Sensors

### Example 4

### Resistance Variances of Gas Sensors with Different Thicknesses when Adsorbing CO Gas

The resistances of the gas sensors (A)-(D) were respectively measured at 50° C., 100° C., 150° C., and 200° C. before being exposed under a carbon monoxide atmosphere. Next, the resistances of the gas sensors (A)-(D) were respectively measured again at 50° C., 100° C., 150° C., and 200° C. after being exposed under a carbon monoxide atmosphere. The results are shown in Table 2.

TABLE 2

| | | Resistance | | Resistance | | Resistance | | Resistance | |
|---|---|---|---|---|---|---|---|---|---|
| | | at | | at | | at | | at | |
| | | 50° C. (Ω) | | 100° C. (Ω) | | 150° C. (Ω) | | 200° C. Ω) | |
| gas | | without | with | without | with | without | with | without | with |
| sensor | thickness | CO | CO | CO | CO | CO | CO | CO | CO |
| A | 0.01 mm | 10500 | 9500 | 6500 | 5000 | 12000 | 10500 | 3500 | 2500 |
| B | 0.05 mm | 1600 | 1200 | 1000 | 420 | 1600 | 850 | 500 | 300 |
| C | 0.10 mm | 1700 | 1400 | 1000 | 620 | 1700 | 1450 | 600 | 450 |
| D | 0.14 mm | 6500 | 5000 | 700 | 400 | 2400 | 1800 | 400 | 200 |

Note that the carbon monoxide had a concentration of 1000 ppm

As shown in Table 2, the gas sensors (A)-(D) of the invention had the ability for sensing carbon monoxide at 50-200° C. (reducing the resistance after reacting with CO). Further, even though the thickness of the gas sensing film was reduced to 0.01 mm, the resistance variance measured before and after carbon monoxide atmosphere exposure was still evident.

### Example 5

### Resistance Variances of Gas Sensors with Different Components when Adsorbing CO Gas

The resistances of the gas sensors (E)-(F) were respectively measured at 50° C., 100° C., 150° C., and 200° C. before being exposed under a carbon monoxide atmosphere. Next, the resistances of the gas sensors (E)-(F) were respectively measured again at 50° C., 100° C., 150° C., and 200° C. after being exposed under a carbon monoxide atmosphere. The results are shown in Table 3.

TABLE 3

| | | | Resistance | | Resistance | | Resistance | | Resistance | |
|---|---|---|---|---|---|---|---|---|---|---|
| | | | at | | at 100° C. | | at 150° C. | | at 200° C. | |
| | Polyimide | | 50° C. (Ω) | | (Ω) | | (Ω) | | (Ω) | |
| gas | precursor | Tin dioxide | without | with | without | with | without | with | without | with |
| sensor | (wt %) | (wt %) | CO | CO | CO | CO | CO | CO | CO | CO |
| E | 80 | 20 | 12100 | 11800 | 10000 | 9200 | 13200 | 12500 | 6500 | 5800 |
| F | 70 | 30 | 11000 | 10500 | 4500 | 3200 | 8200 | 6500 | 1700 | 1000 |
| G | 60 | 40 | 10500 | 9000 | 5500 | 4200 | 9500 | 8800 | 2700 | 2000 |
| H | 50 | 50 | 6500 | 3500 | 700 | 500 | 2200 | 1000 | 500 | 320 |

Note that the carbon monoxide had a concentration of 1000 ppm

As shown in Table 3, the gas sensors (E)-(F) of the invention had the ability for sensing carbon monoxide at 50-200° C. (reducing the resistance after reacting with CO). Further, even though the weight ratio of the tin dioxide was reduced to 20 wt %, the resistance variance measured before and after carbon monoxide atmosphere exposure was still evident.

### Example 6

### Resistance Variances of Gas Sensor Under Different CO Concentrations

The resistance of the gas sensor (A) was measured at 50° C., 100° C., 150° C., and 200° C. before being exposed under a carbon monoxide atmosphere. Next, the resistance of the gas sensor (A) was respectively measured again at 50° C., 100° C., 150° C., and 200° C. after being exposed under a carbon monoxide atmosphere with different CO concentrations. The results are shown in Table 4.

TABLE 4

| | Resistance | | Resistance | | Resistance at | | Resistance at | |
|---|---|---|---|---|---|---|---|---|
| | at 50° C. | | at 100° C. | | 150° C. | | 200° C. | |
| | (Ω) | | (Ω) | | (Ω) | | (Ω) | |
| CO | without | with | without | with | without | with | without | with |
| concentration | CO | CO | CO | CO | CO | CO | CO | CO |
| 1000 ppm | 12500 | 10500 | 7200 | 5800 | 11000 | 9000 | 3700 | 500 |
| 600 ppm | 12500 | 11200 | 7200 | 6400 | 11500 | 9800 | 3700 | 1000 |
| 300 ppm | 12500 | 11800 | 7200 | 6800 | 11500 | 10200 | 3700 | 2300 |

As shown in Table 4, the gas sensor (A) of the invention had the ability for sensing carbon monoxide at 50-200° C. (reducing the resistance after reacting with CO). Further, even though the CO concentration was reduced to 20 wt %, the resistance variance measured before and after carbon monoxide atmosphere exposure was still evident.

In comparison with conventional semiconductor absorbing gas sensors, since the gas sensor of the invention can be used at low temperatures and additional heaters are not required, the gas sensor of the invention has advantages of low power consumption.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A gas sensing material, comprising:
an inorganic metal oxide; and
an organic polymer, wherein the organic polymer comprises a repeat unit having the structure of 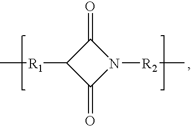
wherein R₁ and R₂ are an independent alkyl group, alkoxy group, alkoxycarbonyl group, aryl group, heteroaryl group, or aliphatic group.

2. The gas sensing material as claimed in claim 1, wherein the inorganic metal oxide comprises SnO₂, ZnO, LaFeO₃, IN₂O₃, WO₃, Ag₂O, or combinations thereof.

3. The gas sensing material as claimed in claim 1, wherein the gas sensing material is able to sense carbon monoxide.

4. The gas sensing material as claimed in claim 1, wherein the gas sensing material is able to sense a desired gas at a temperature of not more than 250° C.

5. The gas sensing material as claimed in claim 1, wherein the gas sensing material is able to perform gas desorption at a temperature of not more than 250° C.

6. The gas sensing material as claimed in claim 1, wherein the gas sensing material is prepared at a temperature of not more than 400° C.

7. The gas sensing material as claimed in claim 1, wherein the inorganic metal oxide is present in an amount of 20-60 parts by weight, and the organic polymer is present in an amount of 40-80 parts by weight, based on the 100 parts by weight of the inorganic metal oxide and the organic polymer.

8. The gas sensing material as claimed in claim 1, wherein the gas sensing material further comprises a polymer dispersant.

9. The gas sensing material as claimed in claim 8, wherein the polymer dispersant comprises polyester, polyimide, or copolymer thereof.

10. The gas sensing material as claimed in claim 8, wherein the polymer dispersant is present in an amount of 10-30 parts by weight, based on the 100 parts by weight of the inorganic metal oxide and the organic polymer.

11. The gas sensing material as claimed in claim 1, wherein the electric resistance, electric capacity, or inductance of the gas sensing material is varied after adsorption of a desired gas.

12. A gas sensor, comprising:
a substrate;
two separated electrodes disposed on the substrate; and
a gas sensing film disposed on the substrate and contacting the two separated electrodes simultaneously, wherein the gas sensing film comprises:
an inorganic metal oxide; and
an organic polymer, wherein the organic polymer comprises a repeat unit having the structure of 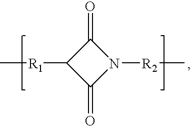
wherein R₁ and R₂ are an independent alkyl group, alkoxy group, alkoxycarbonyl group, aryl group, heteroaryl group, or aliphatic group.

13. The gas sensor as claimed in claim 12, wherein the substrate is a plastic substrate.

14. The gas sensor as claimed in claim 12, wherein the two separated electrodes are independently made of Pt, Au, Ag, or alloys thereof.

15. The gas sensor as claimed in claim 12, wherein the inorganic metal oxide comprises SnO₂, ZnO, LaFeO₃, IN₂O₃, WO₃, Ag₂O, or combinations thereof.

16. The gas sensor as claimed in claim 12, wherein the gas sensing film is able to sense carbon monoxide.

17. The gas sensor as claimed in claim 12, wherein the gas sensing film is able to sense a desired gas at a temperature of not more than 250° C.

18. The gas sensor as claimed in claim 12, wherein the gas sensing film is able to perform gas desorption at a temperature of not more than 250° C.

19. The gas sensor as claimed in claim 12, wherein the gas sensing film is formed at a temperature of not more than 400° C.

20. The gas sensor as claimed in claim 12, wherein the inorganic metal oxide is present in an amount of 20-60 parts by weight, and the organic polymer is present in an amount of 40-80 parts by weight, based on the 100 parts by weight of the inorganic metal oxide and the organic polymer.

21. The gas sensor as claimed in claim 12, wherein the gas sensing film further comprises a polymer dispersant.

22. The gas sensor as claimed in claim 21, wherein the polymer dispersant comprises polyester, polyimide, or copolymer thereof.

23. The gas sensor as claimed in claim 21, wherein the polymer dispersant is present in an amount of 10-30 parts by weight, based on the 100 parts by weight of the inorganic metal oxide and the organic polymer.

24. The gas sensor as claimed in claim 12, wherein the electric resistance, electric capacity, or inductance of gas sensing film is varied after adsorption of a desired gas.
